(19) United States
(12) Patent Application Publication
(10) Pub. No.: US 2018/0075218 A1
(43) Pub. Date: Mar. 15, 2018

(54) WELLNESS DATA MANAGEMENT

(71) Applicant: International Business Machines Corporation, Armonk, NY (US)

(72) Inventors: Stuart B. Benefield, Durham, NC (US); Samuel R. Connor, Apex, NC (US); Jonathan W. Jackson, Durham, NC (US); Joseph Kuczynski, North Port, FL (US)

(21) Appl. No.: 15/262,371

(22) Filed: Sep. 12, 2016

(51) Int. Cl. G06F 19/00

(52) U.S. Cl. CPC G06F 19/3475; G06F 19/324

(57) ABSTRACT

Disclosed aspects relate to wellness data management. A wellness engine detects a triggering event which indicates an anticipated nourishment event that relates to an expected location. Based on both a set of user wellness data and the expected location for the anticipated nourishment event, the wellness engine determines a set of nourishment items. As such, the wellness engine provides a set of nourishment item identifiers for the anticipated nourishment event.

### BACKGROUND

This disclosure relates generally to computer systems, and more particularly, relates to wellness data management. Wellness data management may be desired to be performed as efficiently as possible. The amount of information that needs to be managed with respect to wellness data is increasing. As the amount of information needing to be managed increases, the need for management efficiency may increase.

### SUMMARY

Aspects of the disclosure relate to menu recommendations based on dynamic activity level data. Based on activity intensity and type during the day, our aspects described herein can recommend menu options at a current location where an individual is currently located. Menu recommendations may be based on the current location, the activity type and intensity during a temporal period, the nutritional content of the food, a calorie per day goal of the user, the number of meals remaining in the day, or the like. Such recommended menu options may be provided so as to not put a person over their daily target for a total calorie count, a nutritional composition, or the like.

Disclosed aspects can link an amount of calories and nutritional content still available within a customized nourishment plan for a user. Aspects described herein can present various options for restaurants or menu selections which may be appropriate in order for the user to stay within the appropriate bounds of the nourishment plan of the user. In certain embodiments, aspects of the disclosure relate to making better menu decisions at mealtime based on the activity level and nutritional composition of the food/beverages consumed over a recent historical temporal period.

Aspects of the disclosure relate to wellness data management. A wellness engine detects a triggering event which indicates an anticipated nourishment event that relates to an expected location. Based on both a set of user wellness data and the expected location for the anticipated nourishment event, the wellness engine determines a set of nourishment items. As such, the wellness engine provides a set of nourishment item identifiers for the anticipated nourishment event.

The above summary is not intended to describe each illustrated embodiment or every implementation of the present disclosure.

### BRIEF DESCRIPTION OF THE SEVERAL VIEWS OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a high-level block diagram of a computer system for implementing various embodiments of the present disclosure.

FIG. 2 is a flowchart illustrating a method for wellness data management according to embodiments.

FIG. 3 is a flowchart illustrating a method for wellness data management according to embodiments.

FIG. 4 is a flowchart illustrating a method for wellness data management according to embodiments.

FIG. 5 is a flowchart illustrating a method for wellness data management according to embodiments.

FIG. 6 is a flowchart illustrating a method for wellness data management according to embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the disclosure relate to menu recommendations based on dynamic activity level data. Based on activity intensity and type during the day, our aspects described herein can recommend menu options at a current location where an individual is currently located. Menu recommendations may be based on the current location, the activity type and intensity during a temporal period, the nutritional content of the food, a calorie per day goal of the user, the number of meals remaining in the day, or the like. Such recommended menu options may be provided so as to not put a person over their daily target for a total calorie count, a nutritional composition, or the like.

Disclosed aspects can link an amount of calories and nutritional content still available within a customized nourishment plan for a user. Aspects described herein can present various options for restaurants or menu selections which may be appropriate in order for the user to stay within the appropriate bounds of the nourishment plan of the user. In certain embodiments, aspects of the disclosure relate to making better menu decisions at mealtime based on the activity level and nutritional composition of the food/beverages consumed over a recent historical temporal period.

An application program may be configured to run a mobile device, a web server, a client application of a cloud application, or the like. The application program may allow for configuration of a dietary plan (e.g., total calories, nutritional composition, dietary restrictions, allergies). The application program can track a recent activity level for a user (e.g., duration, activity, intensity). The application program may track a nutrition intake of a user in near time (e.g., calories, composition, vitamins, protein, carbohydrates, fat). Various features may occur in response to a triggering event such as an alarm-style timer for a meal, a manual request by the user, or an eating event for a user. The eating event may be predictive such that it is based on time since last meal, an activity, prediction of calorie depletion (e.g., slow/fast burning calories) below a threshold, or the like.

The application program may suggest to the user a meal that meets their needs and is available based on their location (e.g., a meal at home if the location indicates they are home, a meal at a nearby restaurant). The meal may be suggested based on an inventory of ingredients at home (e.g., smart fridge, Chef Watson) or by meal/nutrition information at nearby dining establishments. In certain embodiments, a payment/delivery mechanism may be established so as to pay/notify the establishment of such a pending request or to dispatch the meal. If the meal is accepted for consumption by the user, the meal can be added into the tracking feature. Activity level can be dynamically monitored as the application program runs in an ongoing basis throughout the day of a user.

Aspects of the disclosure include a method, system, and computer program product for wellness data management using a wellness engine. The wellness engine detects a triggering event (e.g., an electronic calendar event, an exercise event, a time of day, a hunger indicator) which indicates an anticipated nourishment event that relates to an expected location. Based on both a set of user wellness data (e.g., a nourishment plan) and the expected location for the anticipated nourishment event, the wellness engine determines a set of nourishment items. As such, the wellness engine provides a set of nourishment item identifiers for the anticipated nourishment event.

In various embodiments, the wellness engine collects the set of user wellness data. In embodiments, in response to providing the set of nourishment item identifiers for the anticipated nourishment event, the wellness engine receives a selected subset of the set of nourishment items for the anticipated nourishment event. In response to receiving the selected subset of the set of nourishment items for the anticipated nourishment event, the wellness engine may update the set of user wellness data using the selected subset of the set of nourishment items for the anticipated nourishment event.

In embodiments, the detecting, the determining, and the providing each occur in an automated fashion without user intervention. In various embodiments, the detecting, the determining, and the providing each occur in a dynamic fashion to streamline wellness data management. Altogether, the wellness data management may be associated with performance or efficiency benefits (e.g., data security, speed, flexibility, responsiveness, resource usage, productivity). Aspects may save resources such as bandwidth, processing, or memory.

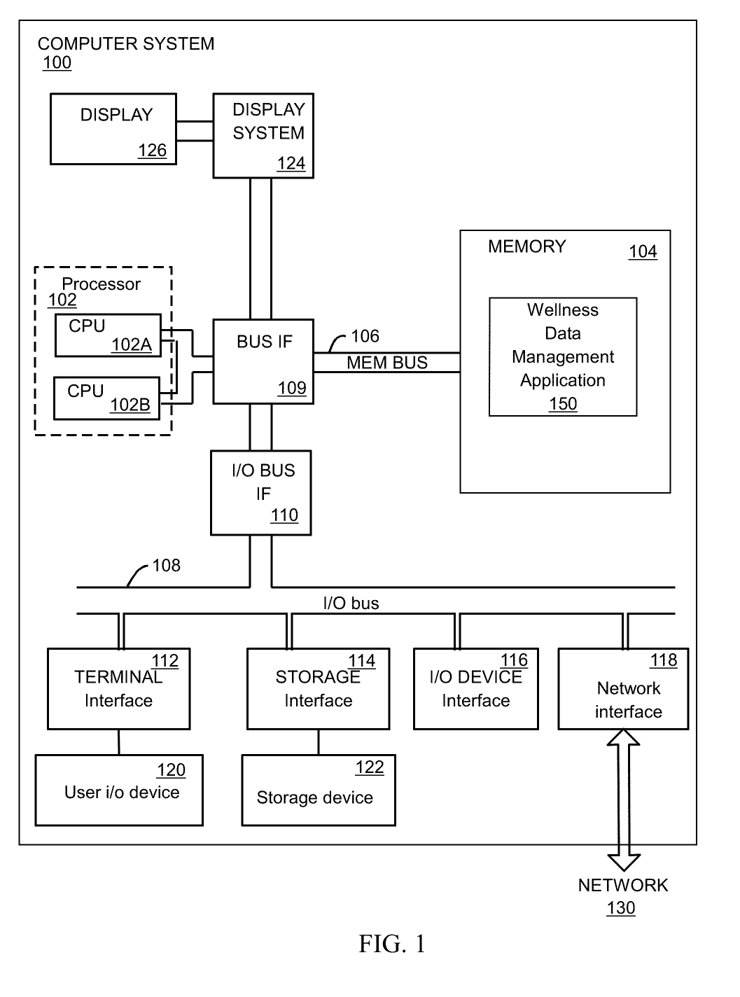

Turning now to the figures, FIG. 1 depicts a high-level block diagram of a computer system for implementing various embodiments of the present disclosure, consistent with various embodiments. The mechanisms and apparatus of the various embodiments disclosed herein apply equally to any appropriate computing system. The major components of the computer system 100 include one or more processors 102, a memory 104, a terminal interface 112, a storage interface 114, an I/O (Input/Output) device interface 116, and a network interface 118, all of which are communicatively coupled, directly or indirectly, for inter-component communication via a memory bus 106, an I/O bus 108, bus interface unit 109, and an I/O bus interface unit 110.

The computer system 100 may contain one or more general-purpose programmable central processing units (CPUs) 102A and 102B, herein generically referred to as the processor 102. In embodiments, the computer system 100 may contain multiple processors; however, in certain embodiments, the computer system 100 may alternatively be a single CPU system. Each processor 102 executes instructions stored in the memory 104 and may include one or more levels of on-board cache.

In embodiments, the memory 104 may include a random-access semiconductor memory, storage device, or storage medium (either volatile or non-volatile) for storing or encoding data and programs. In certain embodiments, the memory 104 represents the entire virtual memory of the computer system 100, and may also include the virtual memory of other computer systems coupled to the computer system 100 or connected via a network. The memory 104 can be conceptually viewed as a single monolithic entity, but in other embodiments the memory 104 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The memory 104 may store all or a portion of the various programs, modules and data structures for processing data transfers as discussed herein. For instance, the memory 104 can store a wellness data management application 150. In embodiments, the wellness data management application 150 may include instructions or statements that execute on the processor 102 or instructions or statements that are interpreted by instructions or statements that execute on the processor 102 to carry out the functions as further described below. In certain embodiments, the wellness data management application 150 is implemented in hardware via semiconductor devices, chips, logical gates, circuits, circuit cards, and/or other physical hardware devices in lieu of, or in addition to, a processor-based system. In embodiments, the wellness data management application 150 may include data in addition to instructions or statements.

The computer system 100 may include a bus interface unit 109 to handle communications among the processor 102, the memory 104, a display system 124, and the I/O bus interface unit 110. The I/O bus interface unit 110 may be coupled with the I/O bus 108 for transferring data to and from the various I/O units. The I/O bus interface unit 110 communicates with multiple I/O interface units 112, 114, 116, and 118, which are also known as I/O processors (IOPs) or I/O adapters (IOAs), through the I/O bus 108. The display system 124 may include a display controller, a display memory, or both. The display controller may provide video, audio, or both types of data to a display device 126. The display memory may be a dedicated memory for buffering video data. The display system 124 may be coupled with a display device 126, such as a standalone display screen, computer monitor, television, or a tablet or handheld device display. In one embodiment, the display device 126 may include one or more speakers for rendering audio. Alternatively, one or more speakers for rendering audio may be coupled with an I/O interface unit. In alternate embodiments, one or more of the functions provided by the display system 124 may be on board an integrated circuit that also includes the processor 102. In addition, one or more of the functions provided by the bus interface unit 109 may be on board an integrated circuit that also includes the processor 102.

The I/O interface units support communication with a variety of storage and I/O devices. For example, the terminal interface unit 112 supports the attachment of one or more user I/O devices 120, which may include user output devices (such as a video display device, speaker, and/or television set) and user input devices (such as a keyboard, mouse, keypad, touchpad, trackball, buttons, light pen, or other pointing device). A user may manipulate the user input devices using a user interface, in order to provide input data and commands to the user I/O device 120 and the computer system 100, and may receive output data via the user output devices. For example, a user interface may be presented via the user I/O device 120, such as displayed on a display device, played via a speaker, or printed via a printer.

The storage interface 114 supports the attachment of one or more disk drives or direct access storage devices 122 (which are typically rotating magnetic disk drive storage devices, although they could alternatively be other storage devices, including arrays of disk drives configured to appear as a single large storage device to a host computer, or solid-state drives, such as flash memory). In some embodiments, the storage device 122 may be implemented via any type of secondary storage device. The contents of the memory 104, or any portion thereof, may be stored to and retrieved from the storage device 122 as needed. The I/O device interface 116 provides an interface to any of various other I/O devices or devices of other types, such as printers or fax machines. The network interface 118 provides one or more communication paths from the computer system 100 to other digital devices and computer systems; these communication paths may include, e.g., one or more networks 130.

Although the computer system 100 shown in FIG. 1 illustrates a particular bus structure providing a direct communication path among the processors 102, the memory 104, the bus interface 109, the display system 124, and the I/O bus interface unit 110, in alternative embodiments the computer system 100 may include different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface unit 110 and the I/O bus 108 are shown as single respective units, the computer system 100 may, in fact, contain multiple I/O bus interface units 110 and/or multiple I/O buses 108. While multiple I/O interface units are shown, which separate the I/O bus 108 from various communications paths running to the various I/O devices, in other embodiments, some or all of the I/O devices are connected directly to one or more system I/O buses.

In various embodiments, the computer system 100 is a multi-user mainframe computer system, a single-user system, or a server computer or similar device that has little or no direct user interface, but receives requests from other computer systems (clients). In other embodiments, the computer system 100 may be implemented as a desktop computer, portable computer, laptop or notebook computer, tablet computer, pocket computer, telephone, smart phone, or any other suitable type of electronic device.

FIG. 1 depicts several major components of the computer system 100. Individual components, however, may have greater complexity than represented in FIG. 1, components other than or in addition to those shown in FIG. 1 may be present, and the number, type, and configuration of such components may vary. Several particular examples of additional complexity or additional variations are disclosed herein; these are by way of example only and are not necessarily the only such variations. The various program components illustrated in FIG. 1 may be implemented, in various embodiments, in a number of different manners, including using various computer applications, routines, components, programs, objects, modules, data structures, etc., which may be referred to herein as “software,” “computer programs,” or simply “programs.”

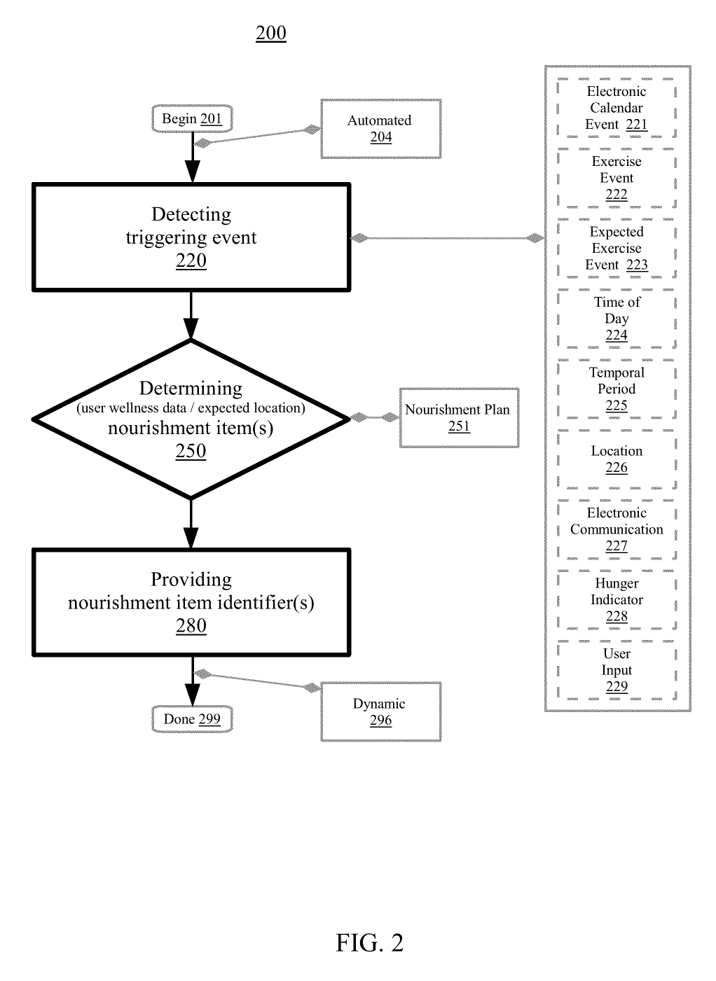

FIG. 2 is a flowchart illustrating a method 200 for wellness data management according to embodiments. The method 200 may begin at block 201. In certain embodiments, the wellness data management may use a social-networking environment (e.g., to detect triggering events, to collect user wellness data, to provide nourishment item identifiers). The social networking environment can include a selection from a group consisting of at least one of: e-mail, calendar, instant messaging (IM), short message services (SMS), wiki, community (e.g., micro-blog, professional connections, photo-sharing), newsfeed, project collaboration, or the like. In embodiments at block 204, the operational steps such as the detecting, the determining, and the providing each occur in an automated fashion without user intervention or manual action (e.g., using automated computing machinery, fully machine-driven without manual stimuli). The automated operational steps may be performed by a wellness engine (e.g., as part of a wellness data management application, as part of the social networking environment, a wellness smartphone application program).

At block 220, a triggering event is detected. The triggering event can indicate an anticipated nourishment event. The anticipated nourishment event can include an upcoming, future, likely-to-occur, or expected meal, snack, hydration, nutrient, caffeine, or a like dietary intake (e.g., coffee, protein shake, steak dinner, kale salad). The anticipated nourishment event may relate to an expected location. For instance, the expected location may include a current location, may include home in the kitchen, may include at a restaurant, may include anywhere on a path from work to home, or the like. The expected location may have various nourishment items available (e.g., on the menu, in-stock). In embodiments, the triggering event may be detected by the wellness engine. Detecting can include receiving, sensing, discovering, acquiring, identifying, or the like.

The triggering event may be selected from a group which can relate to various events, timings, locations, communications, indicators, inputs, or the like. The triggering event may include an electronic calendar event (e.g., scheduled lunch with a job candidate, tickets to a sporting event immediately after work, scheduled early morning workout, charity gala, holiday meal with family, monthly meet-up with friends) at block 221. The triggering event may include an exercise event that can be current or historical (e.g., afternoon warmup run and fitness class, Saturday morning race, twice-weekly spin class, unexpected time spent helping a friend move between homes, Wednesday weight-training) at block 222. The exercise event may tracked by a fitness tracker, smartphone, smartwatch, or the like which notes that the user is or has been exercising.

The triggering event may include an expected exercise event (e.g., marathon training which follows a training plan, a daily workout which the wellness engine has machine learned that the user consistently partakes-in, exercise/workout is scheduled on a calendar of the user, a social media posting indicating the user will run later such as being “headed to the gym”) at block 223. The triggering event may include a time of day (e.g., a regular meal time, 6 am, noon, 6 pm, a scheduled coffee break, a recurring pre-event social hour, an alarm setting) at block 224. The triggering event may include a temporal period (e.g., an amount of time since last snack/meal, an ideal amount of time between protein intakes, a scheduled user fast, an amount of time between nutrition/hydration events during a running race, a caffeine-related intake indicator) at block 225.

The triggering event may include a location (e.g., in kitchen at home, walking around in the restaurant district of a city, entering a restaurant, a destination address for an event, on a driving route from work to home, at or headed to a stadium for a concert or sporting event, in a cafeteria) at block 226. The triggering event may include an electronic communication (e.g., invitation to an event, email or text received from someone such as a spouse discussing bringing dinner home, social media message such as an unexpected visit from a friend who lives in a different city) at block 227. The triggering event may include a hunger indicator (e.g., using a bio-sensor, stomach rumbling, bodily chemical changes, eye gaze at food or towards the kitchen, threshold number of pedometer steps or the like is achieved) at block 228. The triggering event may include a user input (e.g., user starting-up the application program having the wellness engine, user searching for restaurants in the area of user's current location, user appearing to finish a workout and inputting data related to the workout which may indicate a nutritional need) at block 229.

At block 250, a set of nourishment items is determined. The wellness engine may make the determination. Determining can include ascertaining, identifying, resolving, evaluating, formulating, computing, calculating, comparing, or the like. The set of nourishment items may be determined based on both a set of user wellness data and the expected location for the anticipated nourishment event. For instance, the expected location may include a destination location as indicated by travel directions on a smartphone, may include at a lake home without fresh fruits and vegetables, may include at a restaurant where the user is currently seated, may include on a defined segment of a route from home to a house of a friend/family member, or the like.

The set of user wellness data can include various information for a particular individual/user (or group of users such as a family) related to their health (e.g., recent surgery), diseases (e.g., diabetes awareness), exercise (e.g., how much, what kind, when), fitness (e.g., average heart-rate, body mass index), nourishment (e.g., nutrients needed for a temporal period, target caloric consumption), diet (e.g., gluten-free, dairy intake), nutrition (e.g., vitamins, minerals), allergies (e.g., peanuts), wellness preferences (e.g., no caffeine after 6 pm, no pasta after 8 pm), risk factors (e.g., processed sugar intake, addictions/dependencies), or other elements. For example, the set of user wellness data may include target calories, target protein, target nutrients, actual consumed calories or nutrients over a temporal period such as today, activity level today such as steps taken, calories burned, miles bicycled, weightlifting, heart rate over the course of the day so far, other food that has been consumed, expected consumption of food later that day such as at an evening banquet, or the like.

The set of user wellness data may have a nourishment plan at block 251. The nourishment plan can include a dietary plan which can correlate to aspects of the set of user wellness data such as for calories, nutrients, restrictions, allergies, or the like and include features such as flavors (e.g., sweet versus salty), types of food (e.g., beef versus chicken), or the like. The nourishment plan may be dynamic such that varying caloric expenditures may be accounted for (e.g., an unexpected two-mile walk uphill). The nourishment plan may be arranged to enhance an experience of a user by configuring items for which the user may be more likely to enjoy (e.g., based on social media postings, emojis, e-mails). For instance, in certain embodiments, the nourishment plan may be narrowly tailored such that pecan pie may generally be restricted except for Thanksgiving dinner at the house of a particular relative who makes an exceptionally well-flavored pecan pie (e.g., a focused cheat-day or the like). The nourishment plan can factor-in the various information of the set of user wellness data using weighting techniques such as making recent exercise a key factor in how much to consume and achieving nutrient goals for a given day another key factor while deemphasizing (e.g., lesser weighting) to flavors or types of food. For example, different users may have different sentiments on eating the same or similar food for consecutive meals (e.g., grapefruit at every meal for a week).

The nourishment plan may be user-defined (e.g., in dependence on user input at varying stages), predetermined (e.g., deterministic in a sense that the suggestions may be repeated with the same/similar data being present), periodically updated (e.g., various options may be added/deleted based on user ratings), calculated on-the-fly (e.g., for sporadic users who use the wellness engine below a threshold amount such as only a few times per week to receive suggestions), or the like. In embodiments, the set of user wellness data includes a set of consumed dietary intake information for a temporal period (e.g., food/drink consumed since waking-up this morning). Accordingly, the nourishment plan may have a dietary intake plan for the temporal period (e.g., need to have at least 150 grams of protein today). As such, the set of nourishment items may be determined using both the dietary intake plan for the temporal period and the set of consumed dietary intake information for the temporal period (e.g., have already consumed 120 grams of protein by 1pm so an afternoon snack need-not be protein centric when a steak dinner is planned for that evening). As such, pacing the dietary impact across the temporal period may be considered. Thresholds may be utilized to target particular dietary elements that a given user may be focused-on (e.g., limiting caffeine intake due to recent sleeplessness or the like). Various other possibilities not explicitly included but within the scope of the disclosure are contemplated.

At block 280, a set of nourishment item identifiers for the anticipated nourishment event is provided. The wellness engine may provide the set of nourishment item identifiers for the anticipated nourishment event. Providing can include outputting, communicating, transmitting, sending, broadcasting, playing, conveying, displaying, presenting, messaging, publishing, or notifying. For instance, a presentation may be made via still image, video, audio to a user, or various methodologies for displaying content. The set of nourishment item identifiers may correspond with the set of nourishment items. The set of nourishment item identifiers can communicate to a user various food/drink options or the content of such food/drink options. The set of nourishment item identifiers can include text, graphics, still images, video, audio, symbols, or the like. For example, “spinach salad” may be a menu item which include raspberry vinaigrette dressing, dried cranberries, almonds, cherry tomatoes, and feta cheese. Accordingly, “spinach salad” may be communicated to the user in various ways such as via the text “spinach salad”, via graphics showing the various food groups included, a number/representation which shows calories/protein/fat (e.g., calories in regular font with protein in the superscript and fat in the subscript), an indicator of dairy such as the still image of a cow, audio which when played describes the restaurant name and the product, or the like. In certain embodiments, the set of nourishment item identifiers may be provided in a code/look-up table format so as to facilitate product production by a nutrition provider (e.g., restaurant, chef).

In embodiments, the operational steps such as the detecting, the determining, and the providing each occur in a dynamic fashion (e.g., real-time, on-the-fly, ongoing) at block 296 to streamline wellness data management. Method 200 concludes at block 299. Aspects of method 200 may provide performance or efficiency benefits with respect to wellness data management. For example, aspects of method 200 may include positive impacts on user-satisfaction, flexibility, responsiveness, or productivity with respect to menu recommendations based on real-time activity level data. In embodiments, performance or efficiency benefits when nourishment items are selected may occur (e.g., speed, flexibility, resource usage, responsiveness, productivity).

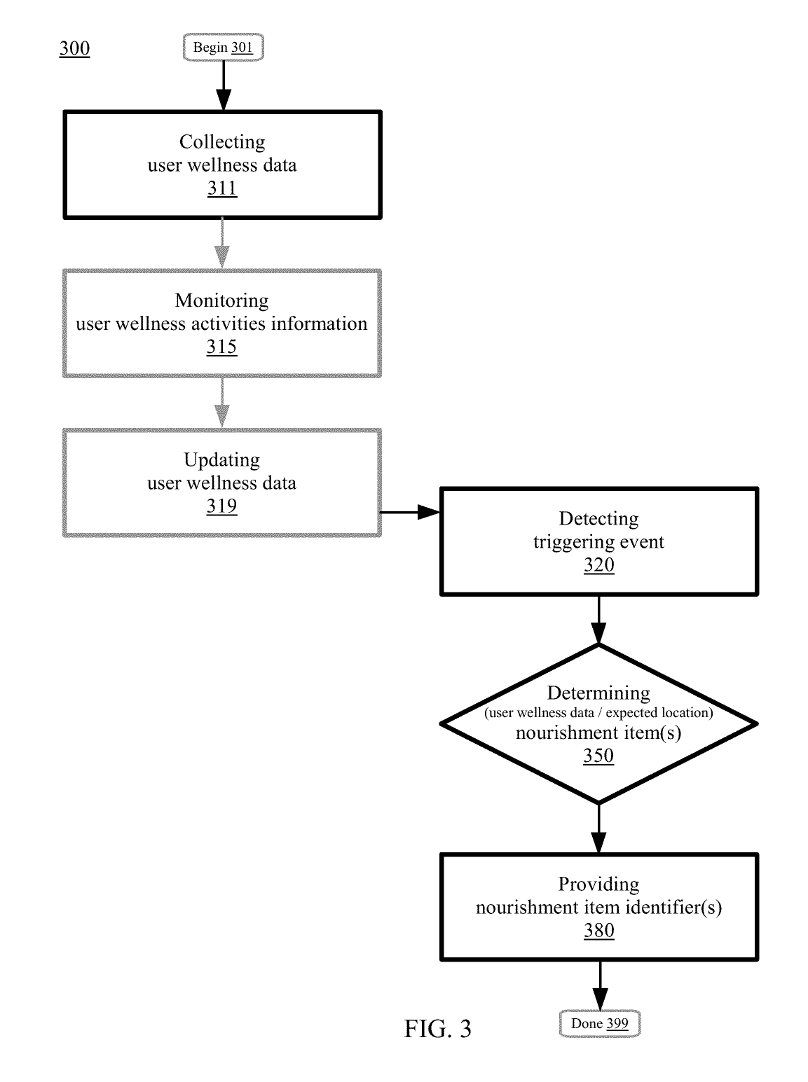

FIG. 3 is a flowchart illustrating a method 300 for wellness data management according to embodiments. Aspects of method 300 may be similar or the same as aspects of method 200 and aspects may be utilized with other methodologies described herein (e.g., method 400, method 500, method 600). The method 300 may begin at block 301.

In embodiments, the set of user wellness data may be collected at block 311. The set of user wellness data may be collected by the wellness engine. The collecting may occur before the determining at block 350, and before or after the detecting at block 320. Collecting can include accumulating, acquiring, aggregating, capturing, gathering, obtaining, logging, saving, or storing. The collecting can occur in an on-going (e.g., dynamic, real-time, streamlined, on-the-fly) basis or periodically (e.g., once per day, once per hour). For example, in advance of determining a suggested set of nourishment items, the wellness engine may collect up-to-date information regarding exercise that has occurred today.

In various embodiments, a set of information for a set of user wellness activities is monitored at block 315. The set of user wellness activities can include exercise, dietary intake, sleep, healthcare visits, or the like. Accordingly, the set of information may be derived-from or arise-out-of such user wellness activities (e.g., what was eaten for breakfast, how many calories were burned via walking). The wellness engine may perform the monitoring. Monitoring can include observing (e.g., watching a reference point), querying (e.g., asking a question), searching (e.g., exploring for a reason), obtaining (e.g., recording a collection), probing (e.g., checking a property), scanning (e.g., reviewing a sample), surveying (e.g., polling a constituent), tracking (e.g., following a characteristic), or the like. For example, a duration and quality of sleep may be monitored for a user.

In various embodiments, the set of user wellness data is updated at block 319. The set of user wellness data may be updated based on the set of information for the set of user wellness activities. The wellness engine may perform the updating in response to monitoring the set of information for the set of user wellness activities. For example, in response to the user taking a nap, the total duration and average quality of sleep for a given day for the user may be updated in a database.

At block 320, the wellness engine detects a triggering event which indicates an anticipated nourishment event that relates to an expected location as described herein. At block 350, based on both a set of user wellness data and the expected location for the anticipated nourishment event, the wellness engine determines a set of nourishment items as described herein. At block 380, the wellness engine provides a set of nourishment item identifiers for the anticipated nourishment event as described herein.

Method 300 concludes at block 399. Aspects of method 300 may provide performance or efficiency benefits with respect to wellness data management. For example, aspects of method 300 may include positive impacts on user-satisfaction, flexibility, responsiveness, or productivity with respect to menu recommendations based on real-time activity level data via various collecting, monitoring, or updating operations. In embodiments, performance or efficiency benefits when nourishment items are selected may occur (e.g., speed, flexibility, resource usage, responsiveness, productivity).

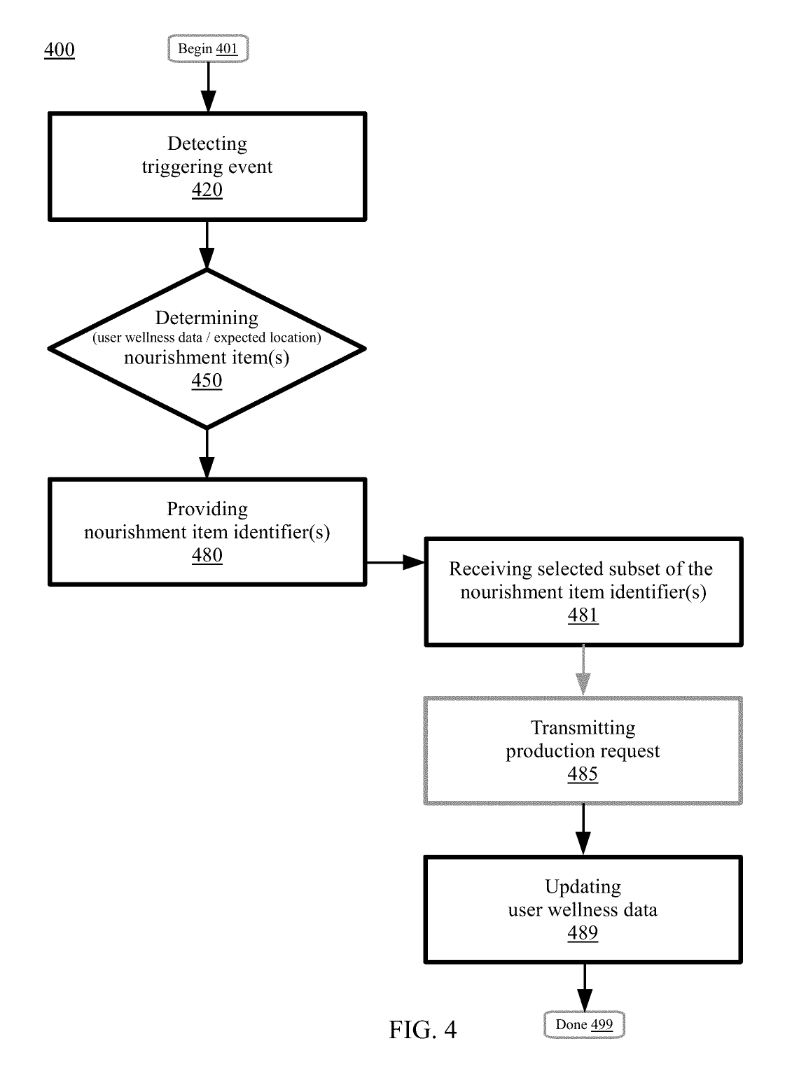

FIG. 4 is a flowchart illustrating a method 400 for wellness data management according to embodiments. Aspects of method 400 may be similar or the same as aspects of method 200 and aspects may be utilized with other methodologies described herein (e.g., method 300, method 500, method 600). The method 400 may begin at block 401.

At block 420, the wellness engine detects a triggering event which indicates an anticipated nourishment event that relates to an expected location as described herein. At block 450, based on both a set of user wellness data and the expected location for the anticipated nourishment event, the wellness engine determines a set of nourishment items as described herein. At block 480, the wellness engine provides a set of nourishment item identifiers for the anticipated nourishment event as described herein.

In embodiments, a selected subset of the set of nourishment items for the anticipated nourishment event is received at block 481. The wellness engine may receive the selected subset of the set of nourishment items for the anticipated nourishment event in response to providing the set of nourishment item identifiers for the anticipated nourishment event. Receiving can include detecting, sensing, accepting as an input, or otherwise accepting delivery of the selected subset of the set of nourishment items for the anticipated nourishment event. The selected subset of the set of nourishment items can include an indication, representation, message, data packet, or the like which indicates nourishment items chosen by the user. For instance, if a user is presented with options for a turkey sandwich, a beef sandwich, or a chicken sandwich accompanied by french fries, sweet potato fries, or potato chips, the selected subset may include a user choice of the turkey sandwich and sweet potato fries.

In various embodiments, a production request for the selected subset of the set of nourishment items for the anticipated nourishment event is transmitted at block 485. Transmitting can include communicating, providing, publishing, routing, sending, presenting, displaying, or outputting. The wellness engine may transmit the production request in response to receiving the selected subset of the set of nourishment items for the anticipated nourishment event. The production request can include a request to purchase, a request for preparation, a request to produce/manufacture, or the like. For example, the production request may include a chef or homemaker being contacted with a message to prepare and produce the selected subset of the set of nourishment items (e.g., the chosen food) for the anticipated nourishment event (e.g., for a specific time).

In embodiments, the set of user wellness data is updated at block 489. The set of user wellness data may be updated/logged using the selected subset of the set of nourishment items for the anticipated nourishment event. The wellness engine may perform the updating in response to receiving the selected subset of the set of nourishment items for the anticipated nourishment event. For example, in response to the user placing the order for the turkey sandwich and sweet potato fries, the expected nutritional content of the meal may be included in the set of user wellness data. Accordingly, the expected nutritional content of the meal may be utilized by the user when the user arrives at home to eat the meal and queries the wellness engine with respect to a drink to have. Accordingly, the wellness engine may seek to balance the dietary intake with a natural fruit-juice-oriented beverage.

Method 400 concludes at block 499. Aspects of method 400 may provide performance or efficiency benefits with respect to wellness data management. For example, aspects of method 400 may include positive impacts on user-satisfaction, flexibility, responsiveness, or productivity with respect to menu recommendations based on real-time activity level data via various receiving, transmitting, or updating operations. In embodiments, performance or efficiency benefits when nourishment items are selected may occur (e.g., speed, flexibility, resource usage, responsiveness, productivity).

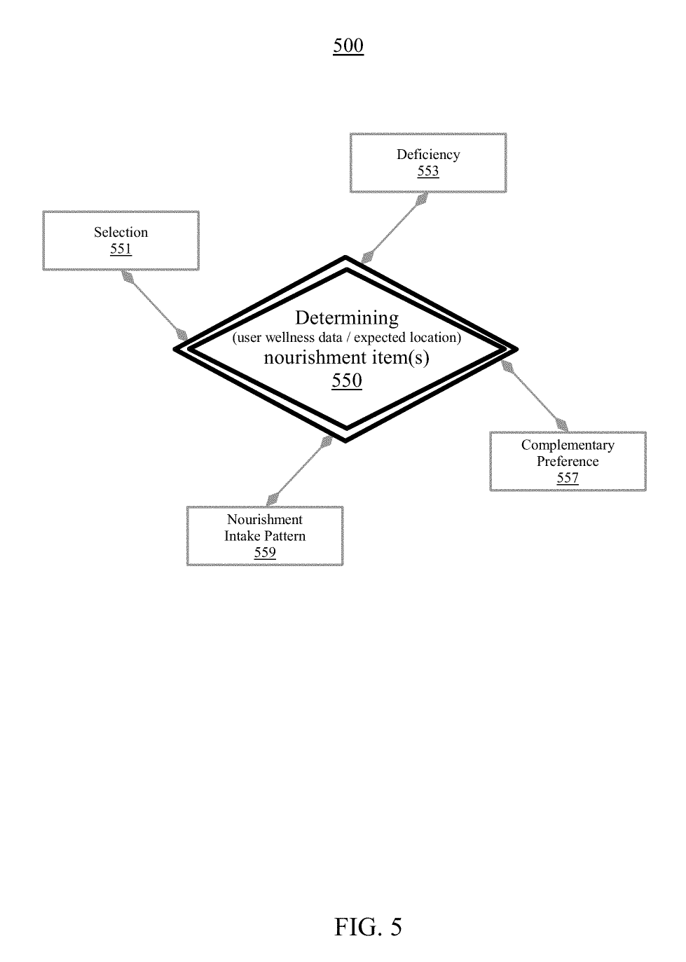

FIG. 5 is a flowchart illustrating a method 500 for wellness data management according to embodiments. Aspects of method 500 may be similar or the same as aspects of method 200 and aspects may be utilized with other methodologies described herein (e.g., method 300, method 400, method 600). At block 550 (similar to block 250, block 350, and block 450), based on both a set of user wellness data and the expected location for the anticipated nourishment event, the wellness engine determines a set of nourishment items as described herein. Aspects described with respect to method 500 may relate to a set of operations when carrying-out the determination.

In embodiments, the determining can include a set of selection operations with respect to block 551. The set of user wellness data may be analyzed. For instance, analyzing can include extracting (e.g., creating a derivation), examining (e.g., performing an inspection), scanning (e.g., reviewing a sample), evaluating (e.g., generating an appraisal), dissecting (e.g., scrutinizing an attribute), resolving (e.g., ascertaining an observation/conclusion/answer), parsing (e.g., deciphering a construct), querying (e.g., asking a question), searching (e.g., exploring for a reason/ground/motivation), comparing (e.g., relating an assessment), classifying (e.g., assigning a designation), or categorizing (e.g., organizing by a feature). Data analysis may include a process of inspecting, cleaning, transforming, or modeling data to discover useful information, suggest conclusions, or support decisions. Data analysis can extract information/patterns from a data set and transform/translate it into an understandable structure (e.g., a data report which can be provided/furnished) for further use.

Accordingly, a target set of nourishment elements (e.g., desired nutrient composition/proportions, craved flavors, preferred nutritional content) can be generated. Generating can include establishing, creating, compiling, constructing, assembling, forming, organizing, configuring, or the like. A set of candidate nourishment items (e.g., restaurant menu items, items having enough time to be prepared and still stay on schedule) for the expected location for the anticipated nourishment event may be retrieved (e.g., acquired, gathered, obtained). The set of candidate nourishment items can be compared with the target set of nourishment elements. Both based on and in response to comparing the set of candidate nourishment items with the target set of nourishment elements, the set of nourishment items may be selected from the candidate set of nourishment items. For example, if the target nourishment elements include antioxidants and omega-3 fatty acids, a meal having salmon, walnuts, and blueberries may be fulfilling. Due to a user not wanting any kind of nuts, salmon and blueberries may still be served but mashed potatoes may be selected by the user as another optional meal element.

In embodiments, the determining can relate to a user deficiency value with respect to block 553. The user deficiency value may be ascertained for a set of nourishment elements for a temporal period (e.g., today, in the past 3 hours, for the next 3 hours, this week). Ascertaining can include identifying, resolving, evaluating, formulating, computing, calculating, comparing, or the like. The user deficiency value may be ascertained using the set of wellness data (e.g., comparing or subtracting current/actual intake values from expected/desired intake values). For example, it may be ascertained that the user is lacking 10 grams protein and 40% of vitamin A with respect to their target dietary intake for the day while have 500 calories still available to eat in accordance with their nourishment plan. In certain embodiments, providing the set of nourishment item identifiers for the anticipated nourishment event can include a set of indications. The user deficiency value may be indicated for the set of nourishment elements (e.g., lacking 10 grams protein and 40% of vitamin A). It can be indicated that the set of nourishment items includes the set of nourishment elements (e.g., eating 100 grams of tuna fish will provide the desired protein and vitamin A while staying under the caloric ceiling). The indications can occur using a symbolizing technique via a graphical user interface, showing to what extent is the deficiency, color-coding various display aspects to indicate the status of the user in various areas for their nourishment plan (e.g., green, yellow, red for accomplished, on-track, need-to-catch-up), or the like.

In embodiments, the determining can include a set of complementary preference operations with respect to block 557. Using the set of wellness data, a user activity event (e.g., intense weightlifting) can be ascertained which correlates to a complementary preference for a set of nourishment elements for a temporal period (e.g., eat protein as soon after lifting as possible and throughout the rest of the day as a complement to the weightlifting). Using the complementary preference for the set of nourishment elements, the set of nourishment items may be computed (e.g., factoring in a whey protein shake immediately after lifting and eating a casein protein centered meal approximately 2-3 hours after the shake). In the example, aspects described herein may assist in building muscle mass or attaining various other fitness/nutrition goals.

In embodiments, the determining can include a set of nourishment intake pattern operations with respect to block 559. The set of wellness data may be analyzed as described herein. Accordingly, a nourishment intake pattern may be ascertained. The nourishment intake pattern may indicate various preferences, findings, machine-learned information, or the like for the user (e.g., never eat sandwiches both for lunch and dinner, prefer hot dinners after cold lunches, minimal breakfast yields a larger lunch, never eat pork twice within a 3-day period, only eat Italian-food when separated by at least 36 hours, cheese and chocolate in the evening whenever possible). Based on the nourishment intake pattern, the set of nourishment items may be computed (e.g., by ruling out certain options which may be disfavored, by weighting preferences for other options which may be favored).

Aspects of method 500 may provide performance or efficiency benefits with respect to wellness data management. For example, aspects of method 500 may include positive impacts on user-satisfaction, flexibility, responsiveness, or productivity with respect to menu recommendations based on real-time activity level data via various different types of determination operations. In embodiments, performance or efficiency benefits when nourishment items are selected may occur (e.g., speed, flexibility, resource usage, responsiveness, productivity).

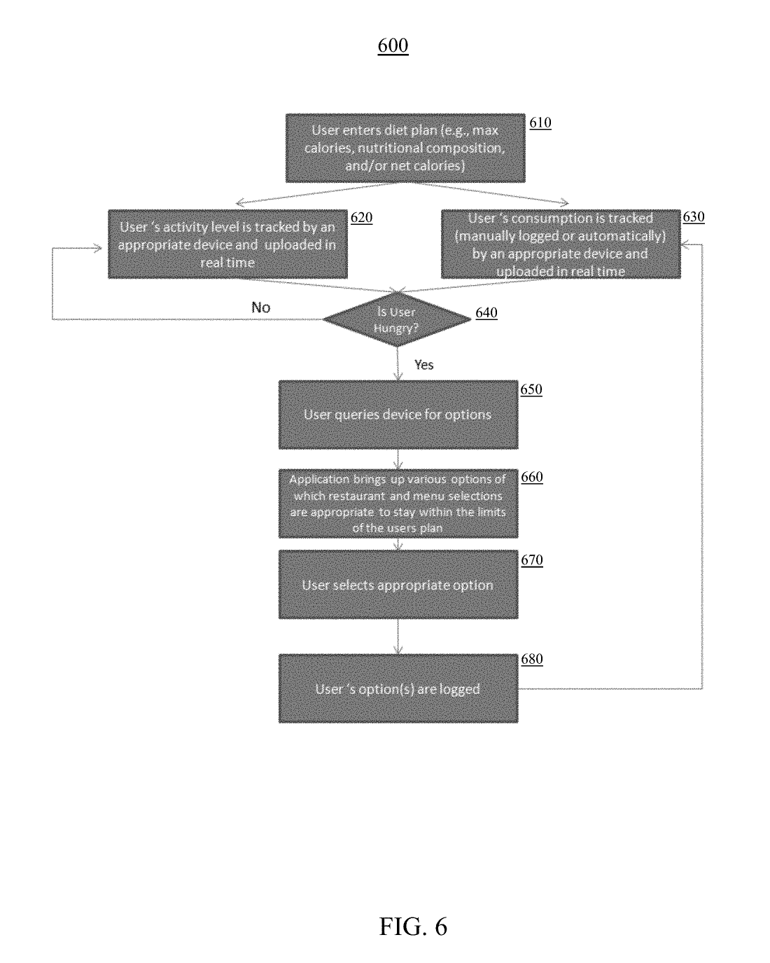

FIG. 6 is a flowchart illustrating a method 600 for wellness data management according to embodiments. At block 610, a user may enter a set of user wellness data such as a diet plan. The activity level of the user may be monitored using a sensor and uploaded by a computer at block 620. Nutritional intake may be captured at block 630. At block 640, a triggering event may be reached with respect to a hunger level of the user. When the user is hungry, the wellness engine may be used to find candidate nourishment items for the anticipated nourishment event at block 650. At block 660, the wellness engine may provide a set of nourishment items related to various restaurants or menu selections in accordance with the diet plan. The user may select a portion of the candidate nourishment items at block 670. At block 680, the chosen items may be recorded for utilization by the set of user wellness data (e.g., for future nourishment events).

In a first example embodiment, the triggering event may include a user input which indicates that the expected location is a current user location (e.g., user communicates current physical presence at the restaurant). The set of user wellness data can indicate a set of threshold nourishment element values for the anticipated nourishment event (e.g., calorie floor/ceilings for the meal, required nutrients, at least 300 calories, no more than 10 grams of fat, at least 2 grams of insoluble fiber, no more than 35 calories from a beverage, no more than 80 mg caffeine). The wellness engine may ascertain that a single entity (e.g., all in the kitchen, all at this one restaurant, all able to get at one grocery store, all at the restaurant the user is sitting at) has the set of nourishment items (e.g., the restaurant has all of the nutrients needed as regular menu items so as to not require more nutritional impact via another meal/dessert).

In a second example embodiment, the triggering event includes an electronic calendar event which indicates that the expected location is a specific region (e.g., tickets to a baseball game downtown, within a threshold such as 5-block radius of a meeting, could include being near a food court in a building). The set of user wellness data indicates a historical intake pattern for the specific region (e.g., the user tends to favor having a bratwurst and a pretzel at the baseball game, always gets a salad of some sort, maybe salads from different places in the food court). Accordingly, the set of nourishment items is based on the historical intake pattern (e.g., providing particular vendors with appropriate sizes/types of bratwursts/pretzels to the liking of the user, a set of salads is presented with other factors such as shrimp versus chicken versus salmon versus beef and calories and dressing may be the various options presented based on a calorie plan or workout schedule for the week or day).

In embodiments, a usage assessment may be generated with respect to the wellness data management. Use of the wellness engine may be metered. For example, mobile processors/memory allocated may be measured based on factors such as quantity allocated, temporal periods of allocation, actual usage, available usage, etc. Such factors may correlate to charge-back or cost burdens which can be defined in-advance (e.g., utilizing usage tiers) or scaled with respect to a market-rate. An invoice or bill presenting the usage, rendered services, fee, and other payment terms may be generated based on the metered use. The generated invoice may be provided (e.g., displayed in a dialog box, sent or transferred by email, text message, traditional mail) to the user for notification, acknowledgment, or payment.

In addition to embodiments described above, other embodiments having fewer operational steps, more operational steps, or different operational steps are contemplated. Also, some embodiments may perform some or all of the above operational steps in a different order. The modules are listed and described illustratively according to an embodiment and are not meant to indicate necessity of a particular module or exclusivity of other potential modules (or functions/purposes as applied to a specific module).

In the foregoing, reference is made to various embodiments. It should be understood, however, that this disclosure is not limited to the specifically described embodiments. Instead, any combination of the described features and elements, whether related to different embodiments or not, is contemplated to implement and practice this disclosure. Many modifications and variations may be apparent to those of ordinary skill in the art without departing from the scope and spirit of the described embodiments. Furthermore, although embodiments of this disclosure may achieve advantages over other possible solutions or over the prior art, whether or not a particular advantage is achieved by a given embodiment is not limiting of this disclosure. Thus, the described aspects, features, embodiments, and advantages are merely illustrative and are not considered elements or limitations of the appended claims except where explicitly recited in a claim(s).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Embodiments according to this disclosure may be provided to end-users through a cloud-computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud-computing resources are provided to a user on a pay-per-use basis, where users are charged only for the computing resources actually used (e.g., an amount of storage space used by a user or a number of virtualized systems instantiated by the user). A user can access any of the resources that reside in the cloud at any time, and from anywhere across the Internet. In context of the present disclosure, a user may access applications or related data available in the cloud. For example, the nodes used to create a stream computing application may be virtual machines hosted by a cloud service provider. Doing so allows a user to access this information from any computing system attached to a network connected to the cloud (e.g., the Internet).

Embodiments of the present disclosure may also be delivered as part of a service engagement with a client corporation, nonprofit organization, government entity, internal organizational structure, or the like. These embodiments may include configuring a computer system to perform, and deploying software, hardware, and web services that implement, some or all of the methods described herein. These embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to exemplary embodiments, other and further embodiments of the invention may be devised without departing from the basic scope thereof, and the scope thereof is determined by the claims that follow. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. “Set of,” “group of,” “bunch of,” etc. are intended to include one or more. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of exemplary embodiments of the various embodiments, reference was made to the accompanying drawings (where like numbers represent like elements), which form a part hereof, and in which is shown by way of illustration specific exemplary embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. But, the various embodiments may be practiced without these specific details. In other instances, well-known circuits, structures, and techniques have not been shown in detail in order not to obscure embodiments.

What is claimed is:

1. A computer-implemented method for wellness data management, the method comprising:
detecting, by a wellness engine, a triggering event which indicates an anticipated nourishment event that relates to an expected location;
determining, by the wellness engine based on both a set of user wellness data and the expected location for the anticipated nourishment event, a set of nourishment items; and
providing, by the wellness engine, a set of nourishment item identifiers for the anticipated nourishment event.

2. The method of claim 1, wherein the triggering event is selected from the group consisting of: an electronic calendar event, an exercise event, an expected exercise event, a time of day, a temporal period, a location, an electronic communication, a hunger indicator, and a user input.

3. The method of claim 1, further comprising:
collecting, by the wellness engine, the set of user wellness data.

4. The method of claim 3, further comprising:
monitoring, by the wellness engine, a set of information for a set of user wellness activities; and
updating, by the wellness engine in response to monitoring the set of information for the set of user wellness activities, the set of user wellness data based on the set of information for the set of user wellness activities.

5. The method of claim 1, further comprising:
receiving, by the wellness engine in response to providing the set of nourishment item identifiers for the anticipated nourishment event, a selected subset of the set of nourishment items for the anticipated nourishment event; and
updating, by the wellness engine in response to receiving the selected subset of the set of nourishment items for the anticipated nourishment event, the set of user wellness data using the selected subset of the set of nourishment items for the anticipated nourishment event.

6. The method of claim 5, further comprising:
transmitting, by the wellness engine in response to receiving the selected subset of the set of nourishment items for the anticipated nourishment event, a production request for the selected subset of the set of nourishment items for the anticipated nourishment event.

7. The method of claim 1, wherein the set of user wellness data includes a nourishment plan.

8. The method of claim 7, wherein the set of user wellness data includes a set of consumed dietary intake information for a temporal period, wherein the nourishment plan includes a dietary intake plan for the temporal period, and wherein the set of nourishment items is determined using both the dietary intake plan for the temporal period and the set of consumed dietary intake information for the temporal period.

9. The method of claim 1, wherein determining, by the wellness engine based on both the set of user wellness data and the expected location for the anticipated nourishment event, the set of nourishment items includes:
generating, by analyzing the set of user wellness data, a target set of nourishment elements;
retrieving a set of candidate nourishment items for the expected location for the anticipated nourishment event;
comparing the set of candidate nourishment items with the target set of nourishment elements; and
selecting, both based on and in response to comparing the set of candidate nourishment items with the target set of nourishment elements, the set of nourishment items from the candidate set of nourishment items.

10. The method of claim 1, wherein determining, by the wellness engine based on both the set of user wellness data and the expected location for the anticipated nourishment event, the set of nourishment items includes:
ascertaining, using the set of wellness data, a user deficiency value for a set of nourishment elements for a temporal period.

11. The method of claim 10, wherein providing, by the wellness engine, the set of nourishment item identifiers for the anticipated nourishment event includes:
indicating the user deficiency value for the set of nourishment elements; and
indicating that the set of nourishment items includes the set of nourishment elements.

12. The method of claim 1, wherein determining, by the wellness engine based on both the set of user wellness data and the expected location for the anticipated nourishment event, the set of nourishment items includes:
ascertaining, using the set of wellness data, a user activity event which correlates to a complementary preference for a set of nourishment elements for a temporal period; and
computing, using the complementary preference for the set of nourishment elements, the set of nourishment items.

13. The method of claim 1, wherein determining, by the wellness engine based on both the set of user wellness data and the expected location for the anticipated nourishment event, the set of nourishment items includes:
ascertaining, by analyzing the set of wellness data, a nourishment intake pattern; and
computing, based on the nourishment intake pattern, the set of nourishment items.

14. The method of claim 1, wherein:
the triggering event includes a user input which indicates that the expected location is a current user location;
the set of user wellness data indicates a set of threshold nourishment element values for the anticipated nourishment event; and
a single entity has the set of nourishment items.

15. The method of claim 1, wherein:
the triggering event includes an electronic calendar event which indicates that the expected location is a specific region;
the set of user wellness data indicates a historical intake pattern for the specific region; and
the set of nourishment items is based on the historical intake pattern.

16. The method of claim 1, wherein the detecting, the determining, and the providing each occur in an automated fashion without user intervention.

17. The method of claim 1, wherein the detecting, the determining, and the providing each occur in a dynamic fashion to streamline wellness data management.

18. A system for wellness data management, the system comprising:
a memory having a set of computer readable computer instructions, and
a processor for executing the set of computer readable instructions, the set of computer readable instructions including:
detecting, by a wellness engine, a triggering event which indicates an anticipated nourishment event that relates to an expected location;
determining, by the wellness engine based on both a set of user wellness data and the expected location for the anticipated nourishment event, a set of nourishment items; and
providing, by the wellness engine, a set of nourishment item identifiers for the anticipated nourishment event.

19. A computer program product for wellness data management, the computer program product comprising a computer readable storage medium having program instructions embodied therewith, wherein the computer readable storage medium is not a transitory signal per se, the program instructions executable by a processor to cause the processor to perform a method comprising:
detecting, by a wellness engine, a triggering event which indicates an anticipated nourishment event that relates to an expected location;
determining, by the wellness engine based on both a set of user wellness data and the expected location for the anticipated nourishment event, a set of nourishment items; and
providing, by the wellness engine, a set of nourishment item identifiers for the anticipated nourishment event.

20. The computer program product of claim 19, wherein at least one of:
the program instructions are stored in the computer readable storage medium in a data processing system, and wherein the program instructions were downloaded over a network from a remote data processing system; or
the program instructions are stored in the computer readable storage medium in a server data processing system, and wherein the program instructions are downloaded over a network to the remote data processing system for use in a second computer readable storage medium with the remote data processing system.
